(19) United States
(12) Patent Application Publication
(10) Pub. No.: US 2026/0075353 A1
(43) Pub. Date: Mar. 12, 2026

(54) INDEPENDENT RADIO WIRELESS HEADSET AND MICROPHONE SYSTEM

(71) Applicant: Shure Acquisition Holdings, Inc., Niles, IL (US)

(72) Inventors: William Wallace Taylor, III, Gurnee, IL (US); Joshua Sven Heise, Harwood Heights, IL (US); Joseph Michael Bradel, South Beloit, IL (US)

(73) Assignee: Shure Acquisition Holdings, Inc., Niles, IL (US)

(21) Appl. No.: 19/313,267

(22) Filed: Aug. 28, 2025

Related U.S. Application Data
(60) Provisional application No. 63/694,005, filed on Sep. 12, 2024.

(51) Int. Cl. H04R 1/10; H04R 1/08

(52) U.S. Cl. CPC H04R 1/1091; H04R 1/08; H04R 2420/07

(57) ABSTRACT

Aspects of the disclosure relate to wireless audio devices with independent wireless radios. The devices may include a headset (or other audio output device(s)) and a microphone (or other audio input device(s). The wireless audio device may include respective wireless radios (e.g., transceivers) for the audio output device(s) and for the audio input device(s) configured for independent wireless communications. The independent wireless radios and corresponding independent communication links allow for both the wireless audio input and output devices to operate without using a depreciated communication profile (e.g., hands-free profile), thereby advantageously providing improved audio quality and user experience.

### CROSS REFERENCE TO RELATED APPLICATIONS

This patent application claims priority to, and the benefit of, U.S. Provisional Ser. No. 63/694,005 , filed Sep. 12, 2024, entitled “INDEPENDENT WIRELESS RADIO HEADSET AND MICROPHONE SYSTEM,” which is incorporated herein by reference in its entirety.

### TECHNICAL FIELD

Aspects of the disclosure relate to wireless headset and microphone systems, including independent wireless radios configurations for the headset and microphone devices.

### BACKGROUND

Wireless audio devices may implement one or more communication profiles defining audio and other (e.g., control) specifications for the established communication with one or more other electronic devices. The wireless audio device may include both audio input (e.g., microphone) and audio output (e.g., speaker, headset, etc.) capabilities. In operation, the input audio signals are transmitted, and the output audio signals are received, via a common wireless transceiver. In such configurations, the input audio data and output audio data share a common communication channel having a limited bandwidth supporting one or more audio channels. For example, the wireless audio system may receive two-channel audio (e.g., left and right audio channels). When the wireless audio device is additionally configured for audio transmission (e.g., via the microphone of the wireless audio device), such as when the wireless audio device implements a “hands-free” communication profile (e.g., hands-free profile (HFP), headset profile (HSP), etc.), the received audio data quality is depreciated to account for the communication channel bandwidth required to support the transmission of detected audio signals from the microphone, thereby degrading the audio quality of the wireless audio device and the resulting user experience.

### SUMMARY

Aspects of the disclosure provide effective, scalable, and reliable technical solutions that address and overcome the problems associated with operation of wireless audio devices, including devices that include both audio input (e.g., microphone) and audio output components.

An example wireless audio system may include a headset (or other audio output device, e.g., speakers) and a microphone (or other audio input device). The wireless audio system may include independent wireless radios (e.g., transceivers) for the audio output device(s) and for the audio input device(s). For example, the headset may be associated with a first transceiver and the microphone may be associated with a second transceiver, where the transceivers are configured to establish independent wireless communication links with one or more other electronic devices (e.g., computer, mobile device, other audio equipment).

With the independent wireless radios and corresponding independent communication links (or connections), the wireless audio systems according to the disclosure may provide both wireless audio input and output devices without using a depreciated communication profile (e.g., hands-free profile), thereby advantageously providing improved audio quality and user experience.

Other aspects of the disclosure provide for the audio input device being removably connected to the headset while being configured to maintain the separate wireless communication link, thereby providing a remote microphone capability while maintaining the audio input and output operations of the wireless audio system.

### BRIEF DESCRIPTION OF THE DRAWINGS

The present disclosure is illustrated by way of example and not limited in the accompanying figures in which like reference numerals indicate similar elements and in which:

FIG. 1 shows a wireless audio system according to the disclosure.

FIG. 2A shows a wireless audio system according to the disclosure in which the audio input device is physically connected with the audio output device via their respective interfaces.

FIG. 2B shows a wireless audio system according to the disclosure in which the audio input device is physically disconnected from the audio output device at their respective interfaces.

FIG. 3 shows the wireless audio system of FIG. 2A, where the electronic device may include a transceiver common to the audio input device and the audio output device, according to the disclosure.

FIG. 4A shows a wireless audio system according to the disclosure in which the audio input device is physically connected with the audio output device via their respective interfaces, and the audio input device and the audio output device use the transceiver of the audio input device.

FIG. 4B shows the wireless audio system of FIG. 4A, where the audio input device and the audio output device use the transceiver of the audio output device.

FIG. 5A shows a wireless audio system according to the disclosure in which the audio input device is physically connected with the audio output device via their respective interfaces, and the audio input device and the audio output device use the transceivers of the audio input device.

FIG. 5B shows the wireless audio system of FIG. 5A, where the audio input device and the audio output device use the transceivers of the audio output device.

FIG. 6A shows a wireless audio system according to the disclosure in which the audio input device is physically connected with the audio output device via their respective interfaces.

FIG. 6B shows the wireless audio system of FIG. 6A in a disconnected state.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

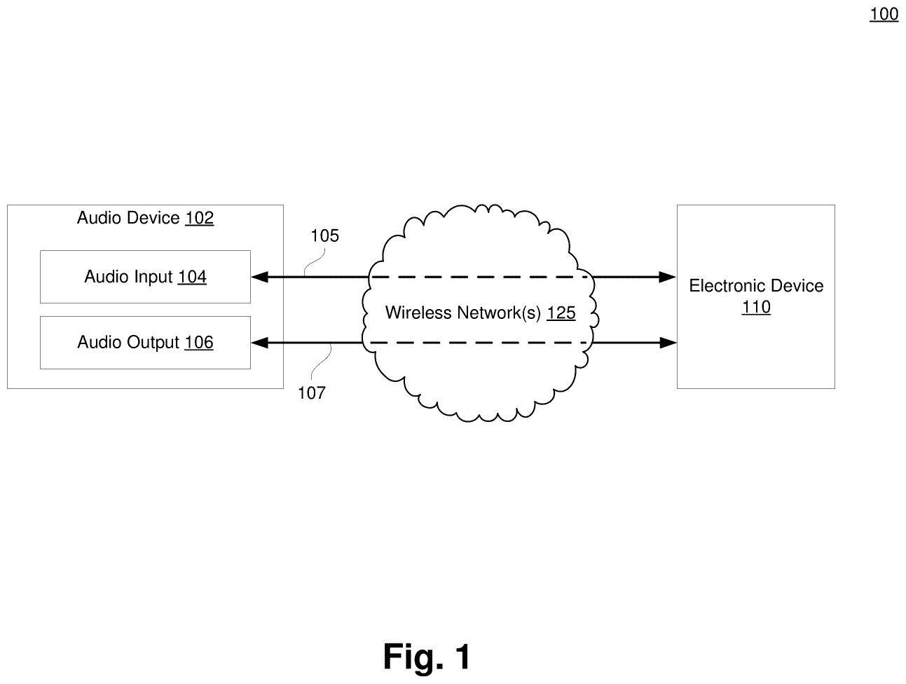

With reference to FIG. 1, an audio system 100 according to the disclosure may include an audio device 102. The audio device 102 may be configured to communicate with one or more electronic devices 110 (e.g., computer, mobile device, smartphone, tablet, or other audio and/or computing device). The audio device 102 and the electronic device(s) 110 may be configured to communicate with each other via one or more wireless networks 125 using one or more wireless communication protocols. The audio device 102 may include one or more audio input devices 104 and one or more audio output devices 106. The audio input device(s) 104 may be microphone(s) or other audio input transducer(s), and the audio output device(s) 106 may include headset(s), headphones, earbud(s), and/or earphone(s) configured to deliver the audio signals directly to the user's ear(s), and/or other audio output transducer(s) (e.g., speakers).

The audio system 100 may be implemented with one or more other audio subcomponents to form an audio system that may include a chain of discrete subcomponents, each configured to perform a specific audio processing functionality. For example, the subcomponents may include microphones, receivers, mixers, amplifiers, speakers, musical instruments, general-purpose computing devices, etc. In one or more examples, the electronic device(s) 110 (e.g., smartphone, tablet, computer, or other audio and/or computing device) may be configured to control operation of the audio device 102 (including component(s) therein).

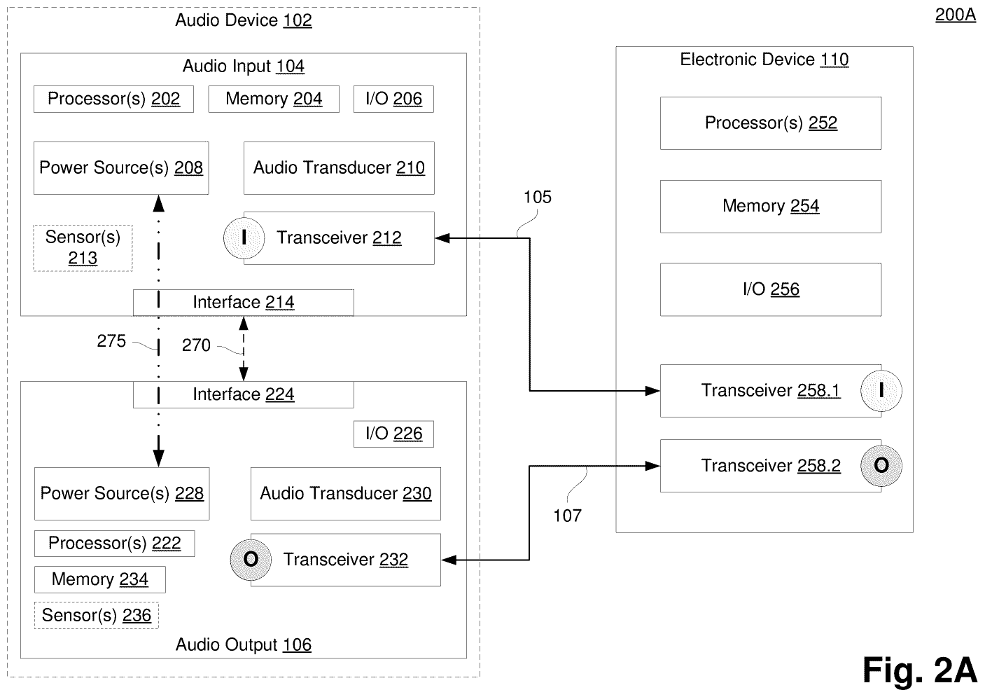

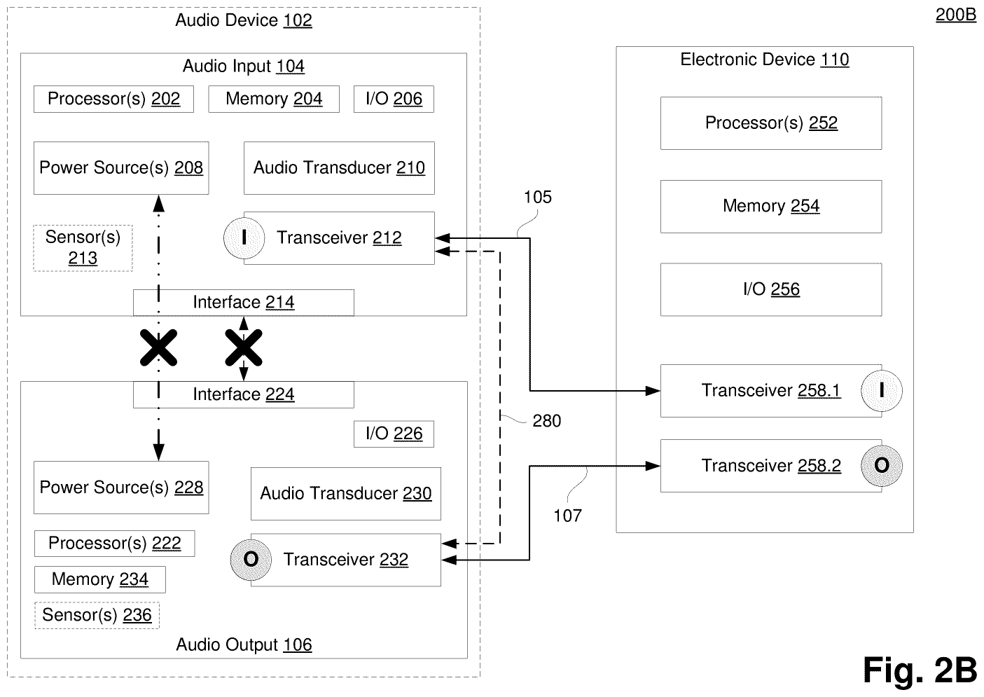

The audio input device(s) 104 and the audio output device(s) 106 may establish independent wireless connections 105, 107 configured to transmit and/or receive data (in the form of data signals) to and/or from the electronic device(s) 110. Additionally, or alternatively, the audio input device(s) 104 and the audio output device(s) 106 may establish connection(s) (e.g., connections 270, 275) with each other (e.g., via interfaces 214, 224; FIGS. 2A-2B), and/or one or more connections (e.g., wireless connection 280; FIG. 2B) via their wireless radios (e.g., transceivers 212, 232). Data signals may be transmitted and/or received between the audio input device(s) 104, the audio output device(s) 106, the electronic device(s) 110, and/or other component(s) of the audio system 100. The information contained in the data signal(s) may include, for example, audio data, commands, statuses, and/or other information sent and received from the components of the audio system 100 for, for example, audio and/or data transmission, monitoring, and/or control purposes. The audio data signals may be on one or more channels.

The audio input device(s) 104 and the audio output device(s) 106 may each include one or more wireless radios (e.g., respective transceivers 212, 232 as shown in FIGS. 2A-2B), where the radio(s) of the audio input device(s) 104 may establish wireless communication link(s) 105 with the electronic device(s) 110 independent of wireless communication link(s) 107 established by the audio output device(s) 106 with the electronic device(s) 110. The communication links may also be referred to as communication connections. Additionally, or alternatively, the audio input device(s) 104 and the audio output device(s) 106 may establish one or more wireless communication link(s) 280 (FIG. 2B) using their wireless radios (e.g., respective transceivers 212, 232). With the independent wireless radios and corresponding independent communication links, the audio system 100 according to the disclosure may provide both wireless audio input device(s) 104 and audio output device(s) 106 that may communicate with the electronic device(s) 110 without using a depreciated communication profile (e.g., hands-free profile, handset profile, etc.), thereby advantageously providing improved audio quality and user experience. In this example, the audio input device(s) 104 and audio output device(s) 106 may function as distinct devices having their own respective communication links with the electronic device 110. The treatment of the audio input device(s) 104 and audio output device(s) 106 as distinct devices allows the audio input device(s) 104 and audio output device(s) 106 to utilize communication profiles providing improved audio quality (as compared to the depreciated communication profile (e.g., hands-free profile (HFP), handset profile (HSP), etc.)). The higher-quality audio communication profiles may include, for example, Advanced Audio Distribution Profile (A2DP), Audio/Video Remote Control Profile (AVRCP). Although aspects of the disclosure are described using wireless connections, wired communication protocols may be used in one or more aspects.

As discussed in more detail below, the audio input device 104 may being removably connected (e.g., physically connected) with the audio output device 106 (e.g., via respective coupling interfaces 214, 224; FIG. 2A-2B) while being configured to maintain the separate wireless communication link with the electronic device(s) 110, thereby providing a remote audio input (e.g., microphone) capability that is separable from the audio output functionality of the audio device 102. The connection formed by the respective coupling interfaces 214, 224 (FIG. 2A-2B) may include one or more wired connections, including data connection(s) (e.g., connection(s) 270) and/or electrical connection(s) (e.g., connection(s) 275 configured for power supply capabilities). The coupling interfaces 214, 224 may collectively be referred to as the “audio input-audio output interface,” “audio input-audio output connection,” or “microphone-headset interface.”

With reference to FIGS. 2A and 2B, audio systems 200A and 200B, according to the disclosure, are illustrated. FIG. 2A illustrates a connected configuration where the audio input device 104 and the audio output device 106 are in a mated physical connection, while FIG. 2B illustrates a disconnected configuration where the audio input device 104 and the audio output device 106 are physically disconnected. Although FIGS. 2A and 2B illustrates a space between the audio input device 104 and the audio output device 106, this spacing is for illustration purposes and to allow for the various connections to be shown. The greyscale circular and oval-shaped icons in FIGS. 2A-5 indicate the input and output components within the particular connection.

The audio input device(s) 104 may be microphone(s) or other audio input transducer(s), and the audio output device(s) 106 may include headset(s), headphones, earphone, or other audio output transducer(s) (e.g., speakers). The audio input device(s) 104 may include one or more of processor(s) 202, memory 204, input/output (I/O) interface(s) 206, power source(s) 208, audio transducer(s) 210, transceiver(s) 212, sensor(s) 213, and/or connection interface(s) 214. One or more data buses may interconnect the processor(s) 202, memory 204, input/output (I/O) interface(s) 206, power source(s) 208, audio transducer(s) 210, transceiver(s) 212, sensor(s) 213, and/or connection interface(s) 214. The audio input device(s) 104 may be implemented using one or more integrated circuits (ICs), software, or a combination thereof, configured to operate as described herein. The memory 204 may comprise any memory, such as a random-access memory (RAM), a read-only memory (ROM), a flash memory, or any other electronically readable memory, or the like. The memory 204 may include one or more memory units. Signals transmitted from and/or received by the audio input device(s) 104 may be encoded in one or more data units. For example, the processor(s) 202 may be configured to generate data units, and process received data units, which conform to any suitable wired and/or wireless communication protocol. The processor(s) 202 may be configured to execute machine-readable instructions stored in memory 204 to perform one or more operations described herein.

The processor(s) 202 may be configured to perform one or more audio processing operations (e.g., mixing operations), digital signal processing (DSP), and/or other signal processing on the audio signals (e.g., received from the transducer 210) to generate processed audio data. The audio processing operations may be performed in the analog or digital domains. If multiple audio processing operations are performed, one or more operations may be performed in the analog domain while one or more other operations may be performed in the digital domain.

The processor(s) 202 may be configured to perform one or more audio processing operations using machine learning (ML), such as using one or more ML models to adjust (e.g., optimize) the audio processing parameters to control the audio processing operations of the processor(s) 202. The ML model may support a generative adversarial network, a bidirectional generative adversarial network, an adversarial autoencoder, or an equivalent thereof. Additionally, or alternatively, the ML model may be a convolutional neural network, a recurrent neural network, a recursive neural network, a long short-term memory (LSTM), a gated recurrent unit (GRU), an unsupervised pretrained network, a space invariant artificial neural network, or any equivalent thereof. The ML model may be trained based on input data and/or output data of the audio device 102 and/or one or more other components of the audio system, and/or one or more other devices in communication with the audio system. The ML model may be trained using different training techniques, such as supervised training, unsupervised training, semi-supervised training back propagation, transfer learning, stochastic gradient descent, learning rate decay, dropout, max pooling, batch normalization, and/or any equivalent deep learning technique.

The audio processing operations may include, for example, the adjustment of audio levels, panning, equalization (EQ), dynamic EQ, compression, multiband compression, summing, filtering, noise reduction, reverb, gain, delay, gating, expansion, de-essing, ducking, saturation, harmonic distortion, one or more modulation effects, sidechaining, adjustments to one or more other audio parameters, and/or one or more other audio processing operations.

Panning may include the process of placing audio elements in the stereo field, so that they appear to come from a particular location in the audio spectrum. For example, by adjusting the left-right balance of a signal, panning may create a sense of space and dimensionality in a mix. Equalization (EQ) may include the process of adjusting the frequency balance of audio tracks to improve balance and/or clarity. Equalization may include cutting or boosting specific frequency ranges to remove unwanted frequencies or enhance desired ones, and/or may be used to achieve a desired tone or timbre. Dynamic EQ may include adjusting the gain of certain frequency bands based on the input level of the audio signal and may be useful in controlling harsh frequencies or taming certain resonances. Compression may include the process of reducing the dynamic range of audio tracks, making loud sounds quieter and quiet sounds louder. By reducing the difference between the loudest and softest parts of a track, compression may provide a more consistent and controlled audio. Multiband Compression is similar to compression, but instead of applying a single level reduction to the entire audio signal, it applies different levels of compression to different frequency bands. Multiband compression may be used to balance out a mix that has a lot of frequency imbalances. Summing may include adding together two or more audio signals to create a single output signal. The summing of audio signals may preserve the relative volume levels and stereo placement. Filtering may include the process of removing or attenuating certain frequencies in an audio signal and may be used to remove unwanted noise and/or resonances, and/or to shape the tone of an audio signal. Noise reduction may include removing unwanted noise from an audio signal, such as removing hiss, hum, and/or other types of noise that may degrade the audio quality. Reverb may include simulating an acoustic environment in which an audio signal was recorded, and may be used to add space, depth, and/or natural reverberation to an audio signal, and/or to create a sense of continuity between different parts of a mix. Gain may include adjusting the overall level of an audio signal and may be used to balance levels of different audio tracks in a mix, and/or to increase or decrease the overall loudness of the audio track. Delay adjustments may include the introduction of a time delay between an audio signal and its output, and/or the introduction of echoes and/or repeats. Delay may be used to create stereo width and/or to create rhythmic effects. Gating may include the attenuating of an audio signal when it falls below a certain level and may be used to remove unwanted noise and/or in controlling the decay of certain sounds. Expansion may be the opposite of compression, where instead of reducing the dynamic range of an audio signal, expansion increases it. Expansion may be used to increase the life and energy to a mix. De-essing may include the process of reducing the level of harsh sibilant sounds in an audio signal, such as “s” and “t” sounds. De-essing may make a mixed sound less harsh and more pleasant to listen to. Ducking may include the reduction of the level of one audio signal when another audio signal is present. This can be useful in making a mixed sound more cohesive and reducing clashes between different tracks. Saturation may include adding harmonic distortion to an audio signal, which may be used to add warmth and character to a mix. Harmonic Distortion may include adding distortion to an audio signal to create new harmonic content. Modulation Effects may include effects (e.g., chorus, flanger, and phaser) that modulate certain aspects of an audio signal, such as pitch, frequency, and/or amplitude. Side chaining may include using the level of one or more audio signals to control the processing of one or more other audio signals. A side chain input may be used, for example, on a compressor or other processor, which allows the level of the separate audio signal(s) to control the amount of processing applied to the other audio signal(s). For example, in a music mix, a side chain input can be used to trigger a compressor on a bass track using the kick drum track as the side chain input. This may cause the bass to be compressed every time the kick drum hits, which can help to create a more cohesive and tight rhythm section. In another example, side chaining may be used in other applications, such as where a music track can be automatically ducked (e.g., reduced in volume) whenever the voiceover is present to ensure that the voiceover remains clear and audible over the music.

Additionally, or alternatively, the audio processing operations may include one or more advanced processing algorithms, such as spatialization, denoising, and/or one or more other advanced audio processing operations. Spatialization may create a sense of space and depth within an audio mix by, for example, placing different sounds in different locations within the stereo or surround sound field, creating a more immersive and realistic listening experience. Spatialization techniques may include panning, reverberation, and delay effects, as well as more advanced techniques like binaural and ambisonic processing. Denoising may include removing unwanted noise from an audio signal (e.g., drum bleed). Noise can come from a variety of sources, including background hum, hiss, or electronic interference. Denoising techniques may include spectral subtraction, noise gating, and/or adaptive filtering, as well as more advanced techniques like ML-based noise reduction algorithms. Denoising techniques may remove and/or attenuate unwanted noise while preserving the quality and clarity of the desired audio signal.

The transceiver(s) 212 may be configured to send/receive signals to/from the electronic device(s) 110 and/or the audio output device(s) 106 using one or more communication protocols. Additionally, or alternatively, the connection interface(s) 214 may be configured to send/receive signals to/from the audio output device(s) 106 (via connection interface(s) 224). The communication protocols may be any wireless communication protocol(s), wired communication protocol, and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.).

The I/O interface 206 may be configured to receive one or more inputs that allow the audio input device(s) 104 to output data signals, including audio data, commands, statuses, and/or other information. The I/O interface 206 may include one or more input connections configured to receive input data and/or signals using one or more wired and/or wireless communication protocols, and/or may include one or more input devices (e.g., keyboard, control panel, graphical user interface (GUI), human-machine interface, or the like). Additionally, or alternatively, the I/O interface 206 may include one or more output connections configured to transmit output data and/or signals using one or more wired and/or wireless communication protocols, and/or may include one or more output devices (e.g., speaker, display, lights, GUI, etc.). The I/O interface 206 may include a dedicated audio interface (e.g., 3.5 mm connector), a general-purpose interface (e.g., a universal serial bus (USB) connector), an XLR connector, or any other type of interface.

The power source(s) 208 may include one or more batteries. The power source(s) 208 may be removable and/or rechargeable. The power source(s) 208 may be recharged by power supplied via the I/O interface 206 and/or the electrical connection 275 established via the interfacing of the connection interfaces 214 and 224. For example, the power source 208 may receive power from the power source(s) 228 of the audio output device 106 via connection 275 established via the interfacing of the connection interfaces 214 and 224.

The audio transducer(s) 210 may be configured to convert sound waves (e.g., acoustic energy) into electrical signals. For example, the transducer(s) 210 may capture audio from sound waves and convert the sound waves into electrical signal(s) corresponding to the detected sound waves. The electrical signal(s) corresponding to the detected audio may be processed by processor(s) 202 and/or provided as an output of the audio input device 104 via the I/O interface 206, transceiver(s) 212, and/or the connection(s) 270 established by connection interfaces 214, 224.

The transceiver(s) 212 may be configured to transmit and/or receive signals using one or more wireless communication protocols, such as an Institution of Electrical and Electronics Engineers (IEEE) 802.11 WIFI protocol, an IEEE 802.15.1 protocol (e.g., Bluetooth), an IEEE 802.15.4 protocol (e.g., Zigbee), one or more other wireless personal area network (WPAN) protocols, a 3rd Generation Partnership Project (3GPP) cellular protocol, FM radio, infrared, one or more optical protocols, ISM (industrial, scientific, and medical) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.), a very high frequency (VHF) band (e.g., 30 MHz-300 MHz band) and/or via (e.g., one or more channels within) an ultra-high frequency (UHF) band (e.g., 300 MHz-3 GHz). The communication protocols that may be used are not limited to these example protocols.

The transceiver(s) 212 may be configured to establish wireless communication link(s) 105 with the electronic device(s) 110 independent of wireless communication link(s) 107 that may be established by the audio output device(s) 106 with the electronic device(s) 110. Additionally, or alternatively, the transceiver(s) 212 may be configured to establish one or more wireless communication link(s) 280 (FIG. 2B) with the transceiver(s) 232 of the audio output device 106. With the independent wireless connections 105 and 107, the audio input device 104 may communicate with the electronic device(s) 110 without using a depreciated communication profile (e.g., hands-free profile, handset profile, etc.), thereby advantageously providing improved audio quality and user experience. The audio input device(s) 104 may function as a distinct device from the audio output device 106, where the audio input device(s) 104 and the audio output device 106 have their own respective communication links 105, 107 with the electronic device 110. The treatment of the audio input device(s) 104 and audio output device(s) 106 as distinct devices allows the audio input device(s) 104 and audio output device(s) 106 to utilize communication profiles providing improved audio quality (as compared to the depreciated communication profile (e.g., hands-free profile (HFP), handset profile (HSP), etc.)). The higher-quality audio communication profiles may include, for example, Advanced Audio Distribution Profile (A2DP), Audio/Video Remote Control Profile (AVRCP).

The connection interface(s) 214 may be configured to engage with connection interface(s) 224 of the audio output device 106 to form a removable mated connection. The connection interface(s) 214 and the connection interface(s) 224 may be complementary shaped to facilitate the removable connection. The type of connection formed between the audio input device(s) 104 and the audio output device(s) 106 at the connection interface(s) 214 and connection interface(s) 224 may be, for example, threaded, magnetic, friction-fit, press-fit, push-fit, snap-fit, twist-and-lock, bayonet, compression, barbed, etc. For magnetic engagement, the audio input device(s) 104 and the audio output device(s) 106 may include one or more magnets and/or ferrous material(s). Additionally, or alternatively, one or more fasteners may be used, such as mechanical fasteners (e.g., hook-and-loop fastener) and/or temporary adhesives.

As shown in FIG. 2A, the engagement of the connection interface(s) 214 with the connection interface(s) 224 may establish one or more data connection(s) (e.g., connection(s) 270) and/or electrical connection(s) (e.g., connection(s) 275 configured for power supply capabilities) between the audio input device(s) 104 and the audio output device(s) 106. The connection(s) may use one or more wired communication and/or power distribution protocols and/or standards. Additionally, or alternatively, as shown in FIG. 2B, the audio input device(s) 104 and the audio output device(s) 106 may establish one or more wireless connections 280 via their respective transceivers 212, 232. The wireless connection(s) 280 may be used for data exchange between audio input device(s) 104 and the audio output device(s) 106 when the audio input device(s) 104 and the audio output device(s) 106 are physically disconnected via the interfaces 214, 224. For example, the audio input device(s) 104 and the audio output device(s) 106 may provide status information, control information, and/or audio information via connection(s) 280.

The sensor(s) 213 may include one or more position sensors configured to detect the position of the audio input device 104 in three-dimensional (3D) space. The sensor(s) 213 may include one or more inertial measurement units (IMUs), such as one or more accelerometers, gyroscopes, and/or magnetometers. The IMUs may measure linear acceleration, angular velocity, and/or magnetic field orientation to calculate the position and orientation of the audio input device 104 in the 3D space. In one or more aspects, the detected position and/or orientation of the audio input device 104 may be used to control one or more operations of the audio input device 104, such as one or more audio processing operations performed by the audio input device 104 (e.g., processor 202). For example, when the audio input device 104 is physically disconnected from the audio output device(s) 106 (as shown in FIG. 2B) and operating, as for example, in a lavalier mode (e.g., as opposed to a boom mode when physically connected), the audio input device 104 may adjust one or more audio processing operations on the audio captured by the audio transducer(s) 210 based on the position and orientation of the audio input device 104 as detected by the sensor(s) 213. Additionally, or alternatively, based on the position and orientation of the audio input device 104 as detected by the sensor(s) 213, the electronic device(s) 110 and/or audio output device 106 may adjust one or more audio processing operations on audio signals received from the audio input device 104.

Additionally, or alternatively, based on the connection-disconnection status of the audio input device(s) 104 and audio output device(s) 106 via the connection interfaces 214, 224, the electronic device(s) 110, audio input device(s) 104, and/or audio output device(s) 106 may adjust one or more respective operational characteristics and/or operational characteristics of one or more other devices of the system. The operational characteristic(s) may include an operational mode (e.g., boom microphone operation, lavalier microphone operation, etc.), communication profiles used by the device(s) of the system, audio processing operations, wired and/or wireless communication characteristics, power mode of one or more devices, mute status of the audio input device 104, and/or other operating parameter(s) of the device(s). For example, the electronic device(s) 110, audio input device(s) 104, and/or audio output device(s) 106 may adjust, based on the connection-disconnection status, their respective audio processing operations, and/or audio processing operations of one or more other devices.

The audio output device(s) 106 may include headset(s), headphones, earphone, or other audio output transducer(s) (e.g., speakers). The audio output device(s) 106 may include one or more of processor(s) 222, memory 234, input/output (I/O) interface(s) 226, power source(s) 228, audio transducer(s) 230, transceiver(s) 232, sensor(s) 236, and/or connection interface(s) 224. One or more data buses may interconnect the processor(s) 222, memory 234, input/output (I/O) interface(s) 226, power source(s) 228, audio transducer(s) 230, transceiver(s) 232, sensor(s) 236, and/or connection interface(s) 224. The audio output device(s) 106 may be implemented using one or more integrated circuits (ICs), software, or a combination thereof, configured to operate as described herein. The memory 234 may comprise any memory, such as a RAM, ROM, a flash memory, or any other electronically readable memory, or the like. The memory 234 may include one or more memory units. Signals transmitted from and/or received by the audio output device(s) 106 may be encoded in one or more data units. For example, the processor(s) 222 may be configured to generate data units, and process received data units, which conform to any suitable wired and/or wireless communication protocol. The processor(s) 222 may be configured to execute machine-readable instructions stored in memory 234 to perform one or more operations described herein.

The processor(s) 222 may be configured to perform one or more audio processing operations (e.g., mixing operations), digital signal processing (DSP), and/or other signal processing on the audio signals (e.g., received by the audio output device 106 via I/O interface 226, connection interface 224, and/or transceiver 232) to generate processed audio data. The audio processing operations may be performed in the analog or digital domains. If multiple audio processing operations are performed, one or more operations may be performed in the analog domain while one or more other operations may be performed in the digital domain.

The audio processing operations may include one or more operations similar to those performable by the processor 202. Similarly, the processor(s) 222 may use ML to perform one or more operations.

The transceiver(s) 232 may be configured to send/receive signals to/from the electronic device(s) 110 and/or the audio output device(s) 106 using one or more communication protocols. Additionally, or alternatively, the connection interface(s) 224 may be configured to send/receive signals to/from the audio output device(s) 106 (via connection interface(s) 224). The communication protocols may be any wireless communication protocol(s), wired communication protocol, and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.).

The I/O interface 226 may be configured to receive one or more inputs that allow the audio output device(s) 106 to output data signals, including audio data, commands, statuses, and/or other information. The I/O interface 226 may include one or more input connections configured to receive input data and/or signals using one or more wired and/or wireless communication protocols, and/or may include one or more input devices (e.g., keyboard, control panel, GUI, human-machine interface, or the like). Additionally, or alternatively, the I/O interface 226 may include one or more output connections configured to transmit output data and/or signals using one or more wired and/or wireless communication protocols, and/or may include one or more output devices (e.g., speaker, display, lights, GUI, etc.). The I/O interface 226 may include a dedicated audio interface (e.g., 3.5 mm connector), a general-purpose interface (e.g., a USB connector), an XLR connector, or any other type of interface.

The power source(s) 228 may include one or more batteries. The power source(s) 228 may be removable and/or rechargeable. The power source(s) 228 may be recharged by power supplied via the I/O interface 226 and/or the electrical connection 275 established via the interfacing of the connection interfaces 214 and 224. For example, the power source 228 may receive power from the power source(s) 208 of the audio input device 104 via connection 275 established via the interfacing of the connection interfaces 214 and 224.

The audio transducer(s) 230 may be configured to convert electrical signals into sound waves (e.g., acoustic energy). For example, the transducer(s) 230 may output sound waves (e.g., as audible sound) corresponding to received electrical signal(s). The electrical signal(s) corresponding to the audio may be processed by processor(s) 222 and/or received as an input of the audio output device 106 via the I/O interface 226, transceiver(s) 232, and/or the connection(s) 270 established by connection interfaces 214, 224.

The transceiver(s) 232 may be configured to transmit and/or receive signals using one or more wireless communication protocols, such as an IEEE 802.11 WIFI protocol, an IEEE 802.15.1 protocol (e.g., Bluetooth), an IEEE 802.15.4 protocol (e.g., Zigbee), one or more other wireless personal area network (WPAN) protocols, a 3rd Generation Partnership Project (3GPP) cellular protocol, FM radio, infrared, one or more optical protocols, ISM (industrial, scientific, and medical) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.), a very high frequency (VHF) band (e.g., 30 MHz-300 MHz band) and/or via (e.g., one or more channels within) an ultra-high frequency (UHF) band (e.g., 300 MHz-3 GHz). The communication protocols that may be used are not limited to these example protocols. The transceiver 232 and transceiver 212 may use the same or different protocol(s).

The transceiver(s) 232 may be configured to establish wireless communication link(s) 107 with the electronic device(s) 110 independent of wireless communication link(s) 105 that may be established by the audio input device(s) 104 with the electronic device(s) 110. Additionally, or alternatively, the transceiver(s) 232 may be configured to establish one or more wireless communication link(s) 280 (FIG. 2B) with the transceiver(s) 212 of the audio input device 104. With the independent wireless connections 105 and 107, the audio output device(s) 106 may communicate with the electronic device(s) 110 without using a depreciated communication profile (e.g., hands-free profile, handset profile, etc.), thereby advantageously providing improved audio quality and user experience. The audio output device(s) 106 may function as distinct device(s) from the audio input device(s) 104, where the audio output device(s) 106 and the audio input device(s) 104 have their own respective communication links 107, 105 with the electronic device 110. The treatment of the audio output device(s) 106 and audio input device(s) 104 as distinct devices allows the audio output device(s) 106 and audio input device(s) 104 to utilize communication profiles providing improved audio quality (as compared to the depreciated communication profile (e.g., hands-free profile (HFP), handset profile (HSP), etc.)). The higher-quality audio communication profiles may include, for example, Advanced Audio Distribution Profile (A2DP), Audio/Video Remote Control Profile (AVRCP).

The connection interface(s) 224 may be configured to engage with connection interface(s) 214 of the audio input device(s) 104 to form a removable mated connection. The connection interface(s) 214 and the connection interface(s) 224 may be complementary shaped to facilitate the removable connection. The type of connection formed between the audio input device(s) 104 and the audio output device(s) 106 at the connection interface(s) 214 and connection interface(s) 224 may be, for example, threaded, magnetic, friction-fit, press-fit, push-fit, snap-fit, twist-and-lock, bayonet, compression, barbed, etc. For magnetic engagement, the audio input device(s) 104 and the audio output device(s) 106 may include one or more magnets and/or ferrous material(s). Additionally, or alternatively, one or more fasteners may be used, such as mechanical fasteners (e.g., hook-and-loop fastener) and/or temporary adhesives.

As shown in FIG. 2A, the engagement of the connection interface(s) 224 with the connection interface(s) 214 may establish one or more data connection(s) (e.g., connection(s) 270) and/or electrical connection(s) (e.g., connection(s) 275 configured for power supply capabilities) between the audio input device(s) 104 and the audio output device(s) 106. The connection(s) may use one or more wired communication and/or power distribution protocols and/or standards. Additionally, or alternatively, as shown in FIG. 2B, the audio output device(s) 106 and the audio input device(s) 104 may establish one or more wireless connections 280 via their respective transceivers 232, 212. The wireless connection(s) 280 may be used for data exchange between audio input device(s) 104 and the audio output device(s) 106 when the audio input device(s) 104 and the audio output device(s) 106 are physically disconnected via the interfaces 214, 224. For example, the audio input device(s) 104 and the audio output device(s) 106 may provide status information, control information, and/or audio information via connection(s) 280.

The sensor(s) 236 may include one or more position sensors configured to detect the position of the audio output device(s) 106 in 3D space. The sensor(s) 236 may include one or more inertial measurement units (IMUs), such as one or more accelerometers, gyroscopes, and/or magnetometers. The IMUs may measure linear acceleration, angular velocity, and/or magnetic field orientation to calculate the position and orientation of the audio output device(s) 106 in the 3D space. In one or more aspects, the detected position and/or orientation of the audio output device(s) 106 may be used to control one or more operations of the audio output device(s) 106, such as one or more audio processing operations performed by the audio output device(s) 106 (e.g., processor 222). For example, the audio output device(s) 106 may adjust audio processing operations to provide spatial audio effects based on the based on the position and orientation of the audio output device(s) 106 as detected by the sensor(s) 236. Additionally, or alternatively, based on the position and orientation of the audio output device(s) 106 as detected by the sensor(s) 236, the electronic device(s) 110 and/or audio input device 104 may adjust one or more audio processing operations on audio signals provided to the audio output device 106.

The electronic device(s) 110 may be a computing device (e.g., desktop computer, laptop computer), mobile computing device (e.g., smartphone, tablet), and/or any other type of device that may be used for one or more audio applications, which may communicate with the audio input device 104 and/or the audio output device 106. The electronic device(s) 110 may directly communicate with/control (e.g., via Bluetooth, IEEE 802.11 protocol(s), etc.) the audio input device 104 and/or the audio output device 106. Additionally, or alternatively, the electronic device(s) 110 may communicate with/control the audio input device 104 and/or the audio output device 106 via a component (e.g., server) of network 125 and/or one or more other devices of the audio system 100, 200.

The electronic device(s) 110 may include one or more of processor(s) 252, memory 254, input/output (I/O) interface(s) 256, and/or transceiver(s) 258. The electronic device(s) 110 may be implemented using one or more integrated circuits (ICs), software, or a combination thereof, configured to operate as described herein. The memory 254 may comprise any memory, such as RAM, ROM, flash memory, or any other electronically readable memory, or the like. The memory 254 may include one or more memory units. Signals transmitted from and/or received by the electronic device(s) 110 may be encoded in one or more data units. For example, the processor(s) 222 may be configured to generate data units, and process received data units, that conform to any suitable wired and/or wireless communication protocol. The processor(s) 222 may be configured to execute machine-readable instructions stored in memory 254 to perform one or more operations described herein.

The processor(s) 222 may be configured to perform one or more audio processing operations (e.g., mixing operations), digital signal processing (DSP), and/or other signal processing on the audio signals (e.g., to be sent to, and/or received from, the audio output device 106 and/or audio input device 104 via I/O interface 256 and/or transceiver(s) 258) to generate processed audio data. The audio processing operations may be performed in the analog or digital domains. If multiple audio processing operations are performed, one or more operations may be performed in the analog domain while one or more other operations may be performed in the digital domain. The audio processing operations may include one or more operations similar to those performable by the processor 202 and/or 222. Similarly, the processor(s) 252 may use ML to perform one or more operations.

The I/O interface 256 may be configured to receive one or more inputs that allow the electronic device(s) 110 to output data signals, including audio data, commands, statuses, and/or other information. The I/O interface 256 may include one or more input connections configured to receive input data and/or signals using one or more wired and/or wireless communication protocols, and/or may include one or more input devices (e.g., keyboard, control panel, GUI, human-machine interface, or the like). Additionally, or alternatively, the I/O interface 256 may include one or more output connections configured to transmit output data and/or signals using one or more wired and/or wireless communication protocols, and/or may include one or more output devices (e.g., speaker, display, lights, GUI, etc.). The I/O interface 256 may include a dedicated audio interface (e.g., 3.5 mm connector), a general-purpose interface (e.g., a USB connector), an XLR connector, or any other type of interface.

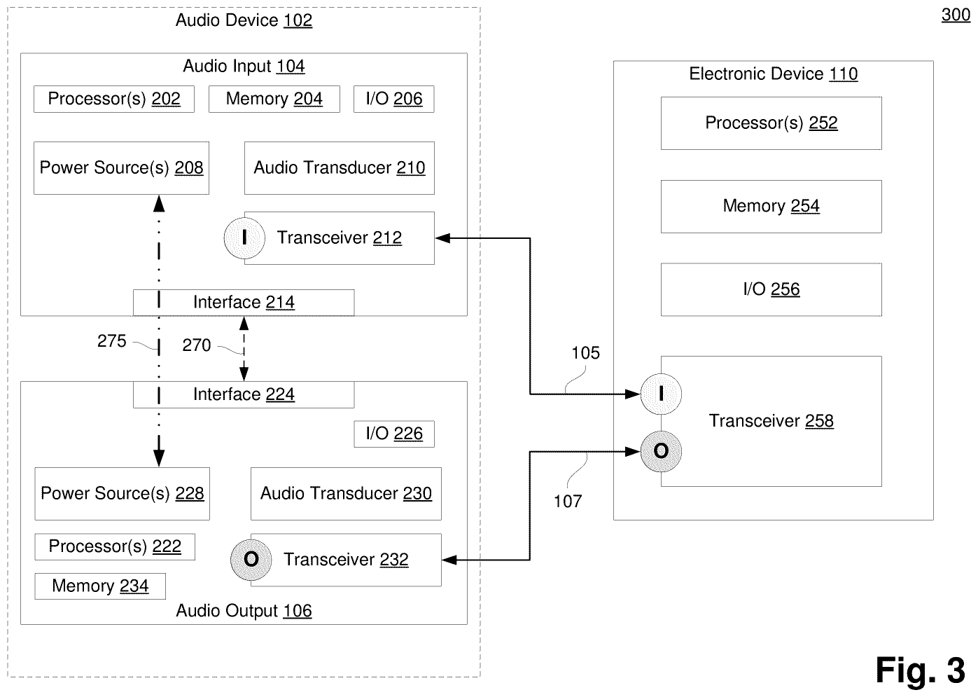

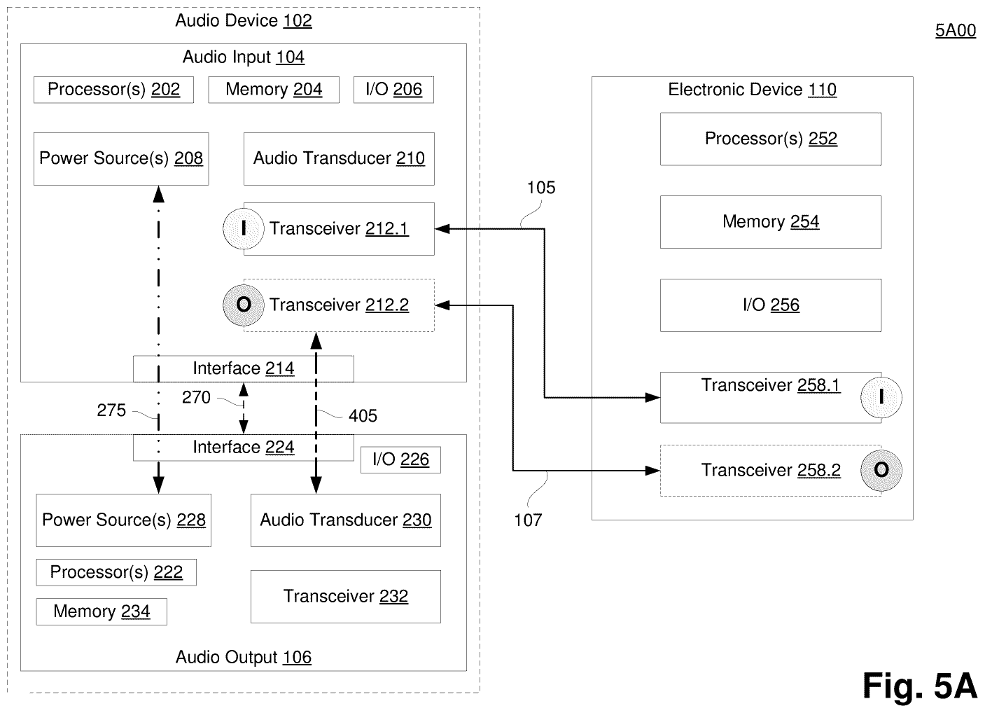

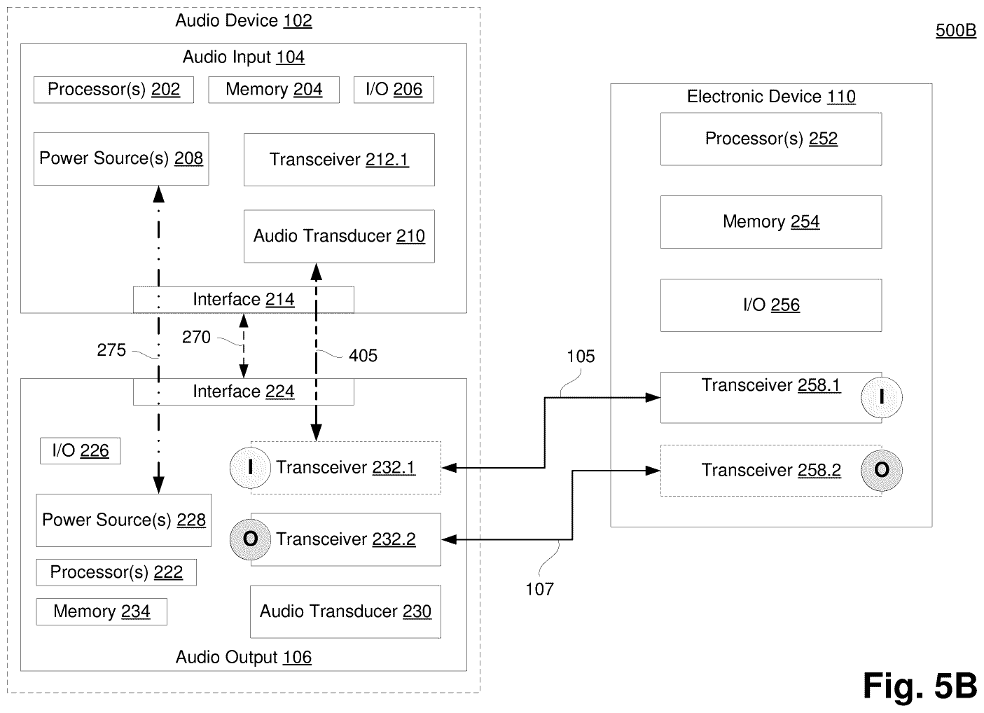

The transceiver(s) 258 may be configured to send/receive signals to/from the audio input device(s) 104 and/or the audio output device(s) 106 using one or more communication protocols. The communication protocols may be any wireless communication protocol(s), wired communication protocol, and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.). As shown in FIGS. 2A-2B and 5, the electronic device(s) 110 may include a corresponding transceiver for the connections 105, 107 established between the audio input device 104 and the audio output device 106. Alternatively, the electronic device 110 may include a transceiver 258 that is configured to establish two or more connections (e.g., 105, 107) between two or more devices (e.g., audio input device 104 and the audio output device 106). For example, as shown in FIG. 3, the transceiver 212 of the audio input device 104 and the transceiver 232 of the audio output device 106 may share a common transceiver 258 of the electronic device(s) 110.

The transceiver(s) 258 may be configured to establish wireless communication link(s) 105 with the audio input device(s) 104 independent of wireless communication link(s) 107 that may be established by the transceiver 258 with the audio output device(s) 106. With the independent wireless connections 105 and 107, the electronic device(s) 110 may communicate with audio input device 104 and/or audio output device 106 without using a depreciated communication profile (e.g., hands-free profile, handset profile, etc.), thereby advantageously providing improved audio quality and user experience.

The electronic device(s) 110 may be configured to treat audio input device(s) 104 and/or audio output device(s) 106 as distinct devices, where the audio input device(s) 104 and the audio output device(s) 106 have their own respective communication links 105, 107 with the electronic device 110. The treatment of the audio input device(s) 104 and audio output device(s) 106 as distinct devices allows the audio input device(s) 104, audio output device(s) 106, and/or electronic device(s) 110 to utilize communication profiles providing improved audio quality (as compared to the depreciated communication profile (e.g., hands-free profile (HFP), handset profile (HSP), etc.)). The higher-quality audio communication profiles may include, for example, Advanced Audio Distribution Profile (A2DP), Audio/Video Remote Control Profile (AVRCP).

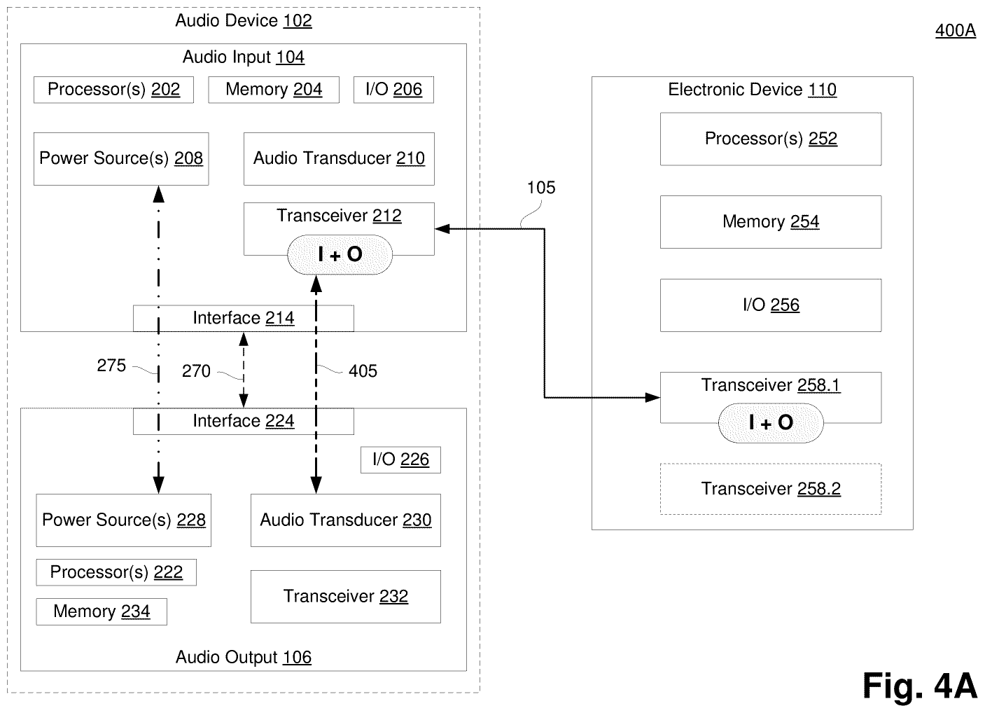

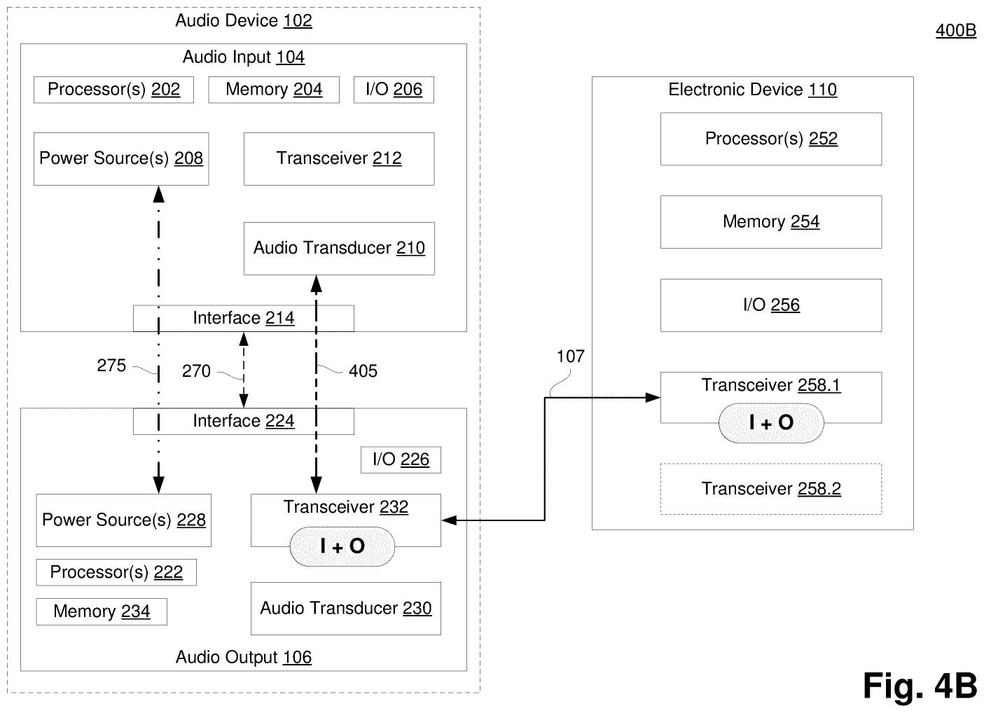

With reference to FIGS. 4A-4B, when the audio input device(s) 104 is connected (e.g., physically connected) with the audio output device(s) 106, the audio device 102 may be configured to operate in a dependent communication mode (instead of the independent communication mode as shown in FIGS. 2A-3) in which the audio input device(s) 104 and the audio output device(s) 106 share a connection 105 or 107 with the electronic device(s) 110. In the dependent communication mode, the audio input device(s) 104 and the audio output device(s) 106 may exchange audio data via a connection 405 established via the interfacing of the audio input device(s) 104 and the audio output device(s) 106 using the connection interfaces 214 and 224. The connection 405 may be a connection separate from the connection 270, or may be established via connection 270. Although the dependent communication mode may require the use of the depreciated communication profiles (e.g., hands-free profile (HFP), handset profile (HSP), etc.)), the dependent communication mode may allow for the audio input device(s) 104 and/or the audio output device(s) 106 to utilize a shared transceiver and established communication link 105, 107. This may facilitate the audio input device(s) 104 and/or the audio output device(s) 106 to operate in a reduced power mode (e.g., by powering down one or more components, such as transceivers 212, 232) to conserve the batteries of the power sources 208 and/or 228.

As shown in FIG. 4A, the transceiver 212 may establish connection 105 with the transceiver 258 of the electronic device(s) 110, and this connection is used to communicate data between the electronic device(s) 110 and the audio input device(s) 104, and/or between the electronic device(s) 110 and the audio output device(s) 106 (via the audio input device 104 and connection 405). In this example, the audio transducer 230 of the audio output device(s) 106 may receive audio data from the audio input device(s) 104, which may have been received by the audio input device(s) 104 via the transceiver 212 (from the electronic device(s) 110). In this configuration, the audio output device(s) 106 may operate in a low-power mode in which its transceiver(s) 232 are powered off or operate in a reduced power mode. This may allow the audio output device(s) 106 to conserve power and reduce the power consumption, such as when the battery of the power source 228 is below a threshold, and/or to increase the recharging of the battery of the power source 228 (e.g., via connection 275 and/or I/O interface 226).

Similarly, as shown in FIG. 4B, the transceiver 232 may establish connection 107 with the transceiver 258 of the electronic device(s) 110, and this connection is used to communicate data between the electronic device(s) 110 and the audio output device(s) 106, and/or between the electronic device(s) 110 and the audio input device(s) 104 (via the audio output device 106 and connection 405). In this example, the audio transducer 210 of the audio input device(s) 104 may transmit audio data to the audio output device(s) 106 to then be transmitted using the transceiver 232 (to the electronic device(s) 110). In this configuration, the audio input device(s) 104 may operate in a low-power mode in which its transceiver(s) 212 are powered off or operate in a reduced power mode. This may allow the audio input device(s) 104 to conserve power and reduce the power consumption, such as when the battery of the power source 208 is below a threshold, and/or to increase the recharging of the battery of the power source 208 (e.g., via connection 275 and/or I/O interface 206).

FIG. 5A is a similar configuration as illustrated in FIG. 4A, but the audio input device(s) 104 may include a second transceiver 212.2 that is configured to establish a second, independent connection 107 in addition to connection 105. In this example, the electronic device(s) 110 may include a second corresponding transceiver 258.2. However, the electronic device(s) 110 may include a common transceiver 258 that establishes both connections 105 and 107 with the audio input device(s) 104. In this example, like in FIG. 4A, the audio data may be exchanged between the audio input device(s) 104 and the audio output device(s) 106 via a connection 405. This may allow the audio device 102 to operate in the independent communication mode using independent wireless connections 105 and 107, thereby facilitating the use of higher-quality audio communication profiles (e.g., Advanced Audio Distribution Profile (A2DP), Audio/Video Remote Control Profile (AVRCP) and avoid using depreciated communication profiles (e.g., hands-free profile, handset profile, etc.). This advantageously provides improved audio quality and user experience.

FIG. 5B is a similar configuration as illustrated in FIG. 4B, but the audio output device(s) 106 may include a second transceiver 232.1 that is configured to establish a second, independent connection 105 in addition to connection 107. In this example, the electronic device(s) 110 may include a second corresponding transceiver 258.1. However, the electronic device(s) 110 may include a common transceiver 258 that establishes both connections 105 and 107 with the audio output device(s) 106. In this example, like in FIG. 4B, the audio data may be exchanged between the audio input device(s) 104 and the audio output device(s) 106 via a connection 405. This may allow the audio device 102 to operate in the independent communication mode using independent wireless connections 105 and 107, thereby facilitating the use of higher-quality audio communication profiles (e.g., Advanced Audio Distribution Profile (A2DP), Audio/Video Remote Control Profile (AVRCP) and avoid using depreciated communication profiles (e.g., hands-free profile, handset profile, etc.). Again, this advantageously provides improved audio quality and user experience.

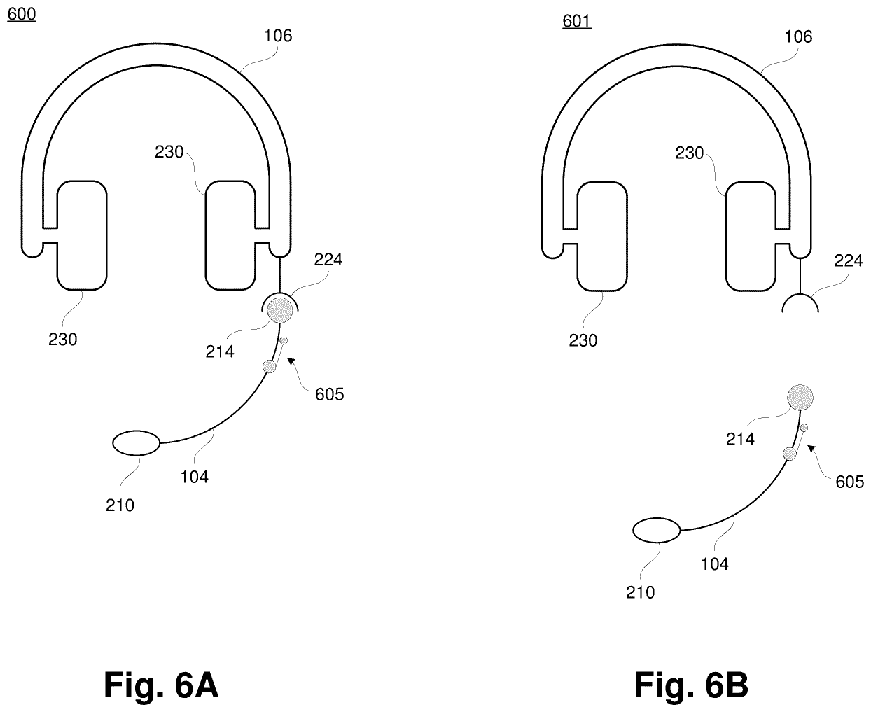

With reference to FIGS. 6A and 6B, audio systems 600 and 601 according to the disclosure are illustrated. FIG. 6A illustrates a connected configuration where the audio input device 104 and the audio output device 106 are in a mated physical connection, while FIG. 6B illustrates a disconnected configuration where the audio input device 104 and the audio output device 106 are physically disconnected. As illustrated, the audio input device 104 may be a detachable microphone and the audio output device 106 may be a headset in which the detachable microphone may be removably connected. According to one or more aspects, the audio input device 104 may include one or more fasteners 605, such as one or more clips, pins, magnetic claps, etc. The audio input device 104 may be attached or otherwise fastened to an object (e.g., clipped to the user's shirt) via the fastener(s) 605. For example, the audio input device 104 may be configured as a lavalier microphone and clipped or otherwise attached to the user's body. In one or more aspects, the fastener(s) 605 may additionally or alternatively include a stand or mount configured to allow the audio input device 104 to be mounted on a surface, laptop, display, or other object.

A wireless audio headset assembly may comprise an audio output device and a detachable audio input device. The audio output device may comprise a first transceiver configured to wirelessly communicate with an electronic device, and a first coupling interface. The detachable audio input device may be configured to be selectively detachably from the audio output device. The audio input device may comprise a second transceiver configured to wirelessly communicate with the electronic device, and a second coupling interface configured to removably connect to the first coupling interface to couple the audio input device and the audio output device together. The first transceiver may be configured to receive audio output signals from the electronic device via a first communication link, and the second transceiver may be configured to transmit audio input signals, corresponding to audio detected by the audio input device, to the electronic device via a second communication link. The first communication link may be established using a first wireless communication protocol and the second communication link may be established using a second wireless communication protocol. The second wireless communication protocol may be different from the first wireless communication protocol. The first communication link may be independent of the second communication link. The first transceiver and the second transceiver may be configured to independently communicate with the electronic device. The first and the second coupling interfaces may be configured to electrically couple the audio input device and the audio output device together. The audio input device may be configured to receive electrical power from the audio output device based on the electrical coupling of the audio input device with the audio output device. The audio output device may be configured to receive electrical power from the audio input device based on the electrical coupling of the audio input device with the audio output device. The first and the second coupling interfaces may be configured to communicatively couple the audio input device and the audio output device together. The audio input device may be configured to provide audio input signals to the audio output device via a wired communication link established between the audio input device and the audio output device. The wired communication link may be established by an interfacing of the audio input device with the audio output device using the first coupling interface and the second coupling interface. The audio input device may be configured to perform one or more audio processing operations on the detected audio to generate the audio input signals. The audio input device may be configured to adjust the one or more audio processing operations based on an orientation of the audio input device, and/or adjust the one or more audio processing operations based on a connection status of the audio input device with the audio output device via the first and the second coupling interfaces. The audio input device may be a microphone and/or the audio output device may be at least one speaker. The first transceiver and/or the second transceiver may be configured to independently wirelessly communicate with the electronic device using an Advanced Audio Distribution Profile (A2DP) or an Audio/Video Remote Control Profile (AVRCP).

An audio device may comprise a microphone comprising a first transceiver configured to wirelessly communicate via a first communication link, and a headset comprising a second transceiver configured to wirelessly communicate via a second communication link independent of the first communication link. The microphone may be configured to be removably connected to the headset. The microphone may be configured to be removably connected to the headset via a microphone-headset interface. The microphone may be configured to supply power to the headset via the microphone-headset interface, and/or the headset may be configured to supply power to the microphone via the microphone-headset interface. The microphone may be configured to provide audio signals corresponding to audio detected by the microphone to the headset via the microphone-headset interface. The microphone may be configured to disable or power off the first transceiver. The disabling or powering off of the first transceiver may be based on one or more characteristics of a power source of the microphone. The headset may be configured to transmit the audio signals received from the microphone using the second transceiver. The first transceiver and/or the second transceiver may be configured to wirelessly communicate using an Advanced Audio Distribution Profile (A2DP) or an Audio/Video Remote Control Profile (AVRCP).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

Hereinafter, various characteristics will be highlighted in a set of numbered clauses or paragraphs. These characteristics are not to be interpreted as being limiting on the invention or inventive concepts but are provided merely to highlight some characteristics as described herein, without suggesting a particular order of importance or relevancy of such characteristics.

Clause 1. A wireless audio headset assembly comprising: an audio output device, wherein the audio output device comprises: a first transceiver configured to wirelessly communicate with an electronic device, and a first coupling interface; and a detachable audio input device configured to be selectively detachabe from the audio output device, wherein the audio input device comprises: a second transceiver configured to wirelessly communicate with the electronic device, and a second coupling interface configured to removably connect to the first coupling interface to couple the audio input device and the audio output device together.

Clause 2. The wireless audio headset assembly of clause 1, wherein the first transceiver is configured to receive audio output signals from the electronic device via a first communication link, and the second transceiver is configured to transmit audio input signals, corresponding to audio detected by the audio input device, to the electronic device via a second communication link.

Clause 3. The wireless audio headset assembly of clause 2, wherein the first communication link is established using a first wireless communication protocol and the second communication link is established using a second wireless communication protocol.

Clause 4. The wireless audio headset assembly of clause 3, wherein the second wireless communication protocol is different from the first wireless communication protocol.

Clause 5. The wireless audio headset assembly of any of clauses 3-4, wherein the first communication link is independent of the second communication link.

Clause 6. The wireless audio headset assembly of any of clauses 1-5, wherein the first transceiver and the second transceiver are configured to independently communicate with the electronic device.

Clause 7. The wireless audio headset assembly of any of clauses 1-6, wherein the first and the second coupling interfaces are configured to electrically couple the audio input device and the audio output device together.

Clause 8. The wireless audio headset assembly of clause 7, wherein the audio input device is configured to receive electrical power from the audio output device based on the electrical coupling of the audio input device with the audio output device.

Clause 9. The wireless audio headset assembly of any of clauses 7-8, wherein the first and the second coupling interfaces are further configured to communicatively couple the audio input device and the audio output device together.

Clause 10. The wireless audio headset assembly of any of clauses 1-9, wherein the audio input device is configured to provide audio input signals to the audio output device via a wired communication link established between the audio input device and the audio output device, the wired communication link being established by an interfacing of the audio input device with the audio output device using the first coupling interface and the coupling second interface.

Clause 11. The wireless audio headset assembly of any of clauses 2-10, wherein the audio input device is configured to: perform one or more audio processing operations on the detected audio to generate the audio input signals; and adjust the one or more audio processing operations based on an orientation of the audio input device.

Clause 12. The wireless audio headset assembly of any of clauses 2-11, wherein the audio input device is configured to: perform one or more audio processing operations on the detected audio to generate the audio input signals; and adjust the one or more audio processing operations based on a connection status of the audio input device with the audio output device via the first and the second coupling interfaces.

Clause 13. The wireless audio headset assembly of any of clauses 1-12, wherein the audio input device is a microphone and the audio output device is at least one speaker.

Clause 14. The wireless audio headset assembly of any of clauses 1-13, wherein the first transceiver and the second transceiver are each configured to independently wirelessly communicate with the electronic device using an Advanced Audio Distribution Profile (A2DP) or an Audio/Video Remote Control Profile (AVRCP).

Clause 15. An audio device comprising: a microphone comprising a first transceiver configured to wirelessly communicate via a first communication link; and a headset comprising a second transceiver configured to wirelessly communicate via a second communication link independent of the first communication link, wherein the microphone is configured to be removably connected to the headset.

Clause 16. The audio device of clause 15, wherein the microphone is configured to be removably connected to the headset via a microphone-headset interface, the microphone being configured to supply power to the headset via the microphone-headset interface, and/or the headset being configured to supply power to the microphone via the microphone-headset interface.

Clause 17. The audio device of any of clauses 15-16, wherein the microphone is configured to be removably connected to the headset via a microphone-headset interface, the microphone being configured to provide audio signals corresponding to audio detected by the microphone to the headset via the microphone-headset interface.

Clause 18. The audio device of clause 17, wherein the microphone is configured to disable or power off the first transceiver, and the headset is configured to transmit the audio signals received from the microphone using the second transceiver.

Clause 19. The audio device of clause 18, wherein the microphone is configured to disable or power off the first transceiver based on one or more characteristics of a power source of the microphone.

Clause 20. The audio device of any of clauses 15-19, wherein the first transceiver and the second transceiver are each configured to wirelessly communicate using an Advanced Audio Distribution Profile (A2DP) or an Audio/Video Remote Control Profile (AVRCP).

1. A wireless audio headset assembly comprising:
an audio output device, wherein the audio output device comprises:
a first transceiver configured to wirelessly communicate with an electronic device, and
a first coupling interface; and
a detachable audio input device configured to be selectively detachable from the audio output device, wherein the audio input device comprises:
a second transceiver configured to wirelessly communicate with the electronic device, and
a second coupling interface configured to removably connect to the first coupling interface to couple the audio input device and the audio output device together.

2. The wireless audio headset assembly of claim 1, wherein the first transceiver is configured to receive audio output signals from the electronic device via a first communication link, and the second transceiver is configured to transmit audio input signals, corresponding to audio detected by the audio input device, to the electronic device via a second communication link.

3. The wireless audio headset assembly of claim 2, wherein the first communication link is established using a first wireless communication protocol and the second communication link is established using a second wireless communication protocol.

4. The wireless audio headset assembly of claim 3, wherein the second wireless communication protocol is different from the first wireless communication protocol.

5. The wireless audio headset assembly of claim 3, wherein the first communication link is independent of the second communication link.

6. The wireless audio headset assembly of claim 1, wherein the first transceiver and the second transceiver are configured to independently communicate with the electronic device.

7. The wireless audio headset assembly of claim 1, wherein the first and the second coupling interfaces are configured to electrically couple the audio input device and the audio output device together.

8. The wireless audio headset assembly of claim 7, wherein the audio input device is configured to receive electrical power from the audio output device based on the electrical coupling of the audio input device with the audio output device.

9. The wireless audio headset assembly of claim 7, wherein the first and the second coupling interfaces are further configured to communicatively couple the audio input device and the audio output device together.

10. The wireless audio headset assembly of claim 1, wherein the audio input device is configured to provide audio input signals to the audio output device via a wired communication link established between the audio input device and the audio output device, the wired communication link being established by an interfacing of the audio input device with the audio output device using the first coupling interface and the coupling second interface.

11. The wireless audio headset assembly of claim 2, wherein the audio input device is configured to: perform one or more audio processing operations on the detected audio to generate the audio input signals; and adjust the one or more audio processing operations based on an orientation of the audio input device.

12. The wireless audio headset assembly of claim 2, wherein the audio input device is configured to: perform one or more audio processing operations on the detected audio to generate the audio input signals; and adjust the one or more audio processing operations based on a connection status of the audio input device with the audio output device via the first and the second coupling interfaces.

13. The wireless audio headset assembly of claim 1, wherein the audio input device is a microphone and the audio output device is at least one speaker.

14. The wireless audio headset assembly of claim 1, wherein the first transceiver and the second transceiver are each configured to independently wirelessly communicate with the electronic device using an Advanced Audio Distribution Profile (A2DP) or an Audio/Video Remote Control Profile (AVRCP).

15. An audio device comprising:
a microphone comprising a first transceiver configured to wirelessly communicate via a first communication link; and
a headset comprising a second transceiver configured to wirelessly communicate via a second communication link independent of the first communication link, wherein the microphone is configured to be removably connected to the headset.

16. The audio device of claim 15, wherein the microphone is configured to be removably connected to the headset via a microphone-headset interface, the microphone being configured to supply power to the headset via the microphone-headset interface, and/or the headset being configured to supply power to the microphone via the microphone-headset interface.

17. The audio device of claim 15, wherein the microphone is configured to be removably connected to the headset via a microphone-headset interface, the microphone being configured to provide audio signals corresponding to audio detected by the microphone to the headset via the microphone-headset interface.

18. The audio device of claim 17, wherein the microphone is configured to disable or power off the first transceiver, and the headset is configured to transmit the audio signals received from the microphone using the second transceiver.

19. The audio device of claim 18, wherein the microphone is configured to disable or power off the first transceiver based on one or more characteristics of a power source of the microphone.

20. The audio device of claim 15, wherein the first transceiver and the second transceiver are each configured to wirelessly communicate using an Advanced Audio Distribution Profile (A2DP) or an Audio/Video Remote Control Profile (AVRCP).
